(19) United States
(12) Patent Application Publication
(10) Pub. No.: US 2011/0239560 A1
(43) Pub. Date: Oct. 6, 2011

(54) Glass Panel Rail Support System

(75) Inventor: David J. Landeros, Industry, CA (US)

(73) Assignee: PRL Glass Systems, Inc., Industry, CA (US)

(21) Appl. No.: 12/753,066

(22) Filed: Apr. 1, 2010

(51) Int. Cl. E04C 2/38; E06B 3/28

(52) U.S. Cl. 52/204.61; 52/656.2

(57) ABSTRACT

A support rail having replaceable decorative side covers for mounting a glass panel on a window, door frame or other mounting structure. The support rail includes opposed longitudinally extending rail sections that cooperate to define an upper U-shaped channel for receiving an edge portion of a glass panel and a lower inverted U-shaped channel for receiving a portion of a mounting structure. A clamping assembly carried by the rail sections operatively connects the sections together to effect securement of the rail to the glass panel and mounting structure. A pair of decorative side covers are slidably mounted along the rail sections by means of flanges formed at the upper and lower ends of the side covers that project into grooves formed in the rail section. A pair of end plates are removably mounted on the rail sections for holding the side covers in place on the rail sections and allowing the removal thereof.

### BACKGROUND OF THE INVENTION

The present invention relates to a rail support system for glass panels to enable the panel to function as a door, window or partition. More particularly, the rail support system of the present invention is of the dry-set or dry glazing type that is easily installed in a variety of applications and includes readily replaceable decorative faceplates.

Glass panels have been used for years in buildings as doors, windows and partitions. A currently popular method of supporting such panels is the use of dry-set rails or “dry glazing” wherein the glass panel is held within a support rail by a clamping means without the use of a cement or other sealant material that requires time to set and makes what is called a “wet glazing” process more labor intensive and time consuming and producing results that are relatively permanent. Dry-set rails address these issues in that they can be economical to manufacture and install and allow for the adjustment, removal and replacement of the glass pane contained therein. While they also can be very versatile in that they can be readily adaptable for a variety of applications, they are relatively inflexible in appearance. Typically, such support rails are formed of extruded aluminum and are provided with a decorative cladding or side covers, (e.g. typically stainless, copper or brass) that are secured to the rails by an adhesive or double-sided tape that effectively permanently affixes the cladding to the support rail. If the side covers become scratched or otherwise damaged or if one merely wishes to change the appearance of the support rail, the options are quite limited. One can either paint the side covers (if not damaged) or replace virtually the entire rail support system. An example of such a rail support system with permanently affixed cladding is found in U.S. Pat. No. 5,069,010. It would be highly desirable to provide a dry-set rail support system for glass panels which retains or improve upon the benefits of existing dry-set rail systems, but which additionally allows for the simple replacement of the decorative side covers on the support rails in the event of damage, or simply to effect an aesthetic change of the rail support system, without the need to replace the entire system. The present invention obtains these results.

### SUMMARY OF THE INVENTION

Briefly, the rail support system of the present invention comprises a pair of longitudinally extending rail sections joined together in an opposed parallel disposition so as to define an upper U-shaped channel for receiving an edge portion of a glass panel and a lower inverted U-shaped channel for receiving a portion of a window or door frame or other mounting structure, and an adjustable securement means for operatively connecting the two rail sections and drawing the sections together about the glass panel and to the mounting structure to effect securement of the support rail to the glass panel and mounting structure. A decorative replaceable side cover is slidably mounted on each rail section and a removable end plate is affixed to the ends of the joined sections, securing the side covers in place on the rails.

To provide the removable mounting of the decorative side covers, the opposed rail sections preferably each define a vertically extending cover support surface and a longitudinally extending groove formed in an upper surface of the rail section, inwardly of the cover support surface, for receiving in a sliding fitment a depending flange formed by the upper inner edge portion of one of the side covers. The lower edge portions of the side covers preferably each define an inwardly extending flange terminating in a raised lip portion adapted to extend about and mate with the lower end portion of the adjacent rail section whereby the decorative side covers can be slid onto the rails and secured in place by a pair of complimentary end plates that are removeably secured to the extended ends of the two joined rail sections. To remove the side covers, it is only necessary to remove one of the end plates from the joined rail sections and slide the side covers along and off the two rail sections.

### BRIEF DESCRIPTION OF THE DRAWINGS

FIG. 1 is an end view of the rail support system of the present invention secured to the upper and lower end portions of a glass panel.

FIG. 2 is a cross-sectional end view of the lower portion of the rail support system of the present invention.

FIG. 3 is an exploded perspective view of an end portion of the glass panel rail support system of the present invention.

FIG. 4 is a partial perspective view of an alternate embodiment of a decorative side panel for use with the rail support system of the present invention.

FIG. 5 is a cross-sectional view of the support rail system of the present invention illustrating the use of an alternate side panel configuration.

### DETAILED DESCRIPTION OF THE PREFERRED EMBODIMENTS

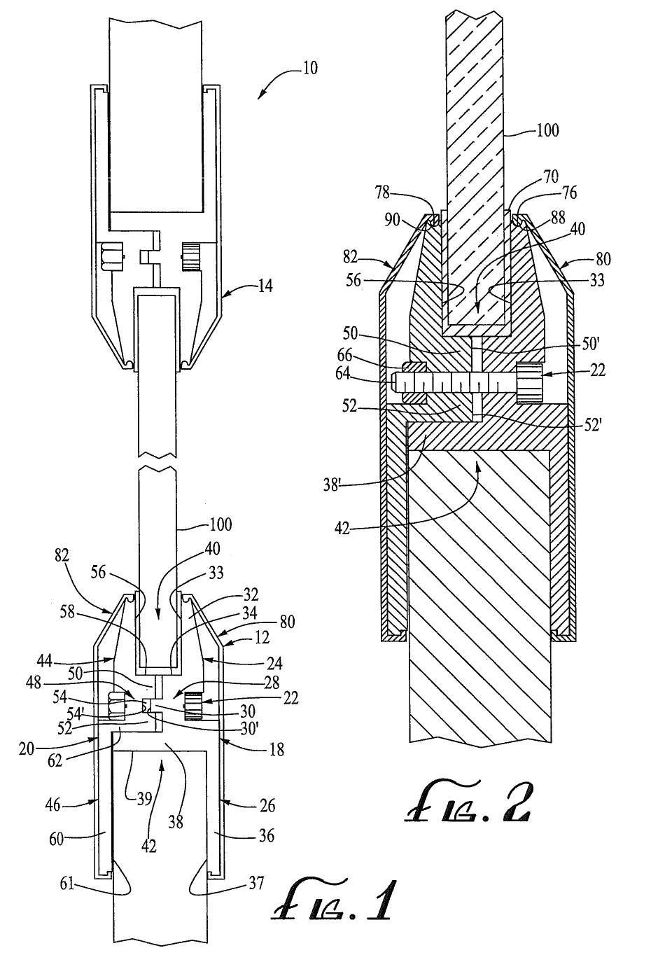

Referring now in detail to the drawings, the glass panel rail support system 10 of the present invention typically comprises a lower support rail 12 and an upper support rail 14, as illustrated in FIG. 1. In certain smaller applications, only the lower support rail 12 of the glass support system is employed. As both the upper and lower support rails are identical in configuration, the following description will be of the lower rail 12 only. It is to be understood, unless otherwise stated, that the terms upper and lower are used herein with respect to the orientation of the lower support rail 12.

The lower support rail 12 of system 10 is adapted to be secured to and extend substantially the entire length of the bottom edge portion of a glass panel 100. Support rail 12 comprises a male section 18, a female section 20 and a clamping assembly 22 for joining together rail sections 18 and 20, as will be described.

The male rail section 18 is preferably formed of extruded aluminum so as to be durable and light weight and defines an upper mounting portion 24, a lower mounting portion 26, a vertical wall 28 extending therebetween and a horizontal flange 30 projecting inwardly from wall 28. The upper mounting portion 24 of the male rail section 18 defines a vertical upstanding arm 32 and a horizontal support surface 34, the inner surface of arm 32 defining an upper clamping surface 33. The lower mounting portion 26 of the male rail section 18 defines a vertical depending leg 36 and a horizontal wall 38, the inner surface of leg 36 defining a lower clamping surface 37 and the inner surface of wall 38 defining a channel wall surface 39.

The female rail section 20 also is preferably formed of extruded aluminum and defines an upper mounting portion 44, a lower mounting portion 46, a vertical wall 48 extending therebetween and upper and lower vertically spaced and inwardly projecting horizontal flanges 50 and 52. The flanges 50 and 52 define a recess 54 therebetween sized so as to receive the horizontal flange 30 on the male rail section 18, as seen in FIG. 1. The upper mounting portion 44 of the female rail section 20 defines a vertical upstanding clamping surface 56 and a horizontal support surface 58 adapted to cooperate with surfaces 33 and 34 of the male rail section 18 to define the upper channel 40 for receiving a lower edge portion of glass panel 100. The lower mounting portion 46 of female rail section 20 defines a vertical depending leg 60 and a horizontal wall 62, the inner surface of leg 60 defining a lower clamping surface 61 that cooperates with surfaces 36 and 37 of the male rail section 18 to define channel 42.

In the embodiment of the invention illustrated in the drawings, the clamping assembly 22 comprises a plurality of equidistantly spaced, threadably engaged, bolts 64 and nuts 66 that project through a corresponding plurality of aligned apertures 66′ and 66″ in the central walls 28 and 48 of rail sections 18 and 20, as seen in FIG. 3. Tightening of the nuts 66 about bolts 44, preferably with a torque wrench to ensure uniform tightening, pulls the two rail sections together, causing the upper clamping surfaces 33 and 56 to bear against the sides of a gasket 70 and glass panel 100 and the lower clamping surfaces 37 and 61 to bear against the mounting surface to effect the securement of the rail 16 to the glass panel and mounting structure. A U-shaped gasket 70 formed of a suitable flexible rubber or plastic material preferably is provided in channel 40 between clamping surfaces 33 and 56 to enable the rail sections to securely grip the glass panel without scratching or otherwise damaging the panel.

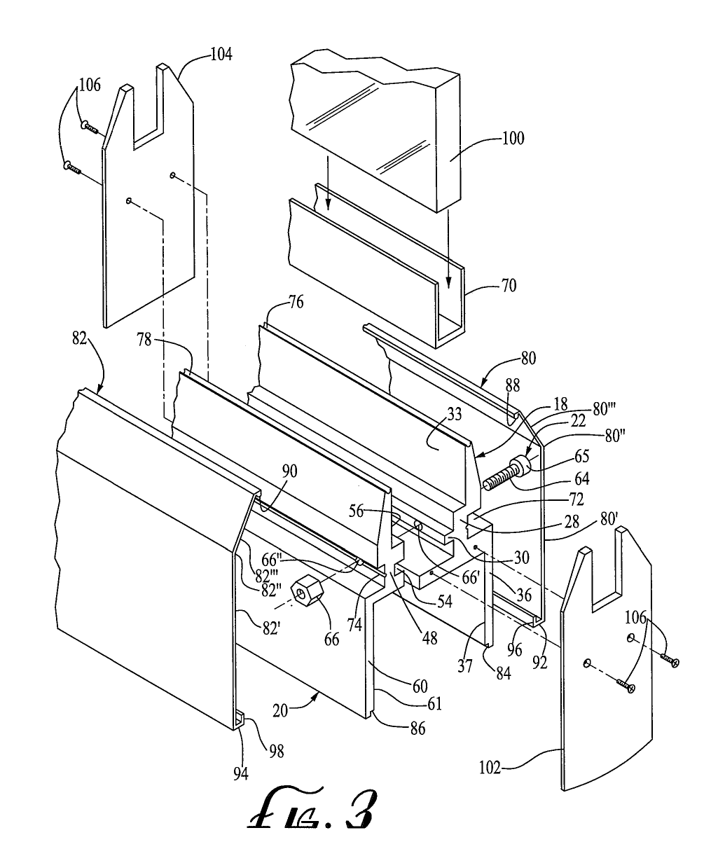

As seen in FIG. 2, with the rail sections joined together by the clamping assembly 22, the extended end 38′ of the wall 38 on the male rail section 18 abuts the upper end of the clamping surface 61 on the female rail section 20, defining the minimum widths of channels 40 and 42 that are sized for given glass panel thicknesses and for the thickness of the mounting surface to which the rail 12 is to be secured. However, the extended ends 50′ and 52′ of flanges 50 and 52 respectively are preferably spaced slightly from vertical wall 28 and the end 30′ of flange 30 is slightly spaced from the end 54′ of recess 54 so as to provide a relatively loose fit of the flange 30 on rail section 18 within the recess 54 of rail section 20 and allow for slight relative pivotal movement between the male and female rail sections 18 and 20 upon the tightening of nuts 66 on bolts 44, to ensure a tight gripping of the glass panel by the two rail sections.

In the rail configuration illustrated in FIGS. 1-3, rail walls 28 and 48 are preferably inwardly offset to define longitudinally extending recesses 72 and 74 in the two rail sections to accommodate the head portions 65 of bolts 64 and the nuts 66 in the clamping assembly 22, as seen in FIG. 2.

To provide the support rail 12 with a removable decorative side covers or faceplates 80 and 82, the upper mounting portions of the male and female rail sections 18 and 20 each define a longitudinally extending groove 76 or 78 therein which, upon the joining together of the two rail sections, extend in parallel disposition along the length of the support rail 12. The lower inner end portions of the depending legs 36 and 60 of the two rail sections define cutout areas 84 and 86. The decorative covers 80 and 82 preferably conform to the general profile of the rail sections. Thus, in the rail configurations illustrated in FIGS. 1-3, the side covers define vertical walls 80′ and 82′ that taper inwardly at 80″ and 82″ into inclined upper surfaces 80′″ and 82″′. The upper inner end portions of the inclined cover surfaces 80′″ and 82″′ define downwardly inclined flanges 88 and 90 respectively. The lower ends of the vertical cover walls 80′ and 82′ define inwardly extending flanges 92 and 94 that terminate in upstanding lips 96 and 98. So configured, the decorative cover 80 can be easily slid over and along the male rail section 18 with its upper flange 88 being disposed within groove 76 and the lower flange 92 thereon extending under the lowermost end of the depending leg 36 of the male rail section 18 such that the upstanding lip 96 at the lower end of the cover is received within cutout area 84 of the leg so as to continue to provide a smooth wall surface for the lower channel 42. Decorative panel 82 is similarly slid onto and over the female rail section with the upper flange 94 thereon disposed within groove 78 and the lower panel flange 94 extending about the underside of leg 60 such that the upstanding lip 98 is received within cutout area 86. When the panels are slid into position such that the extended ends thereof are substantially flush with the extended ends of the opposed rail sections, end plates 102 and 104 are removably secured to the extended ends of the support rail 12, preferably by means of threaded fastening members 106, to prevent any relative sliding movement between the decorative side covers and the rail section. So secured, panels 80 and 82 provide the glass panel support rail system of the present invention with an attractive appearance and allow the user to readily replace the panels in the event of scratching or other damage to the existing side covers or to change the color or ornamental appearance of the rails by simply removing the end plates from the rails, sliding the old covers off the rails, sliding the new panels onto the rails and replacing the end plates.

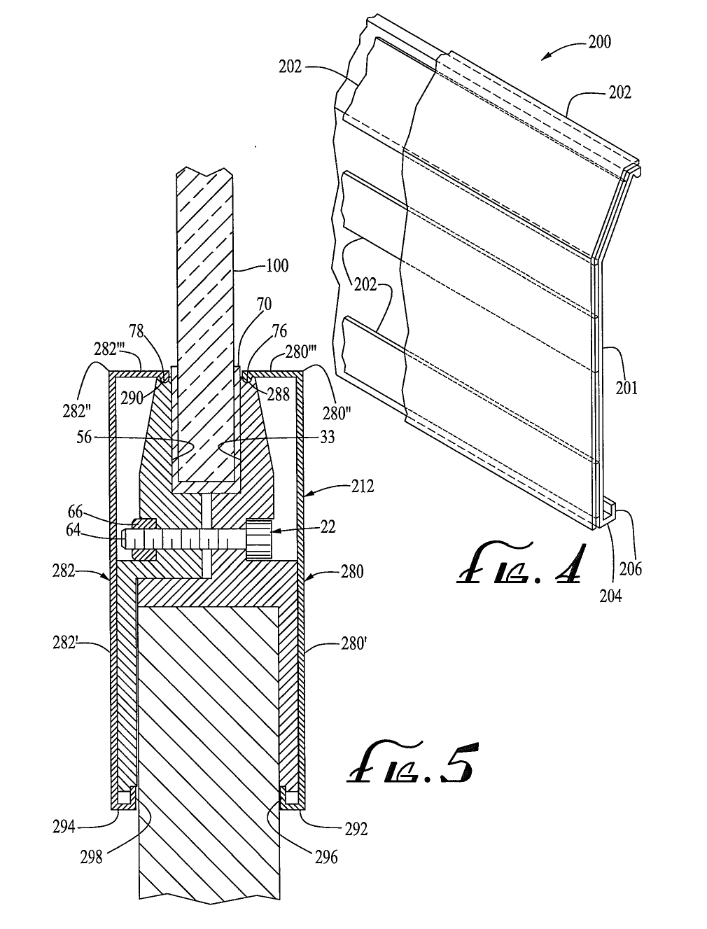

The above described side cover configuration is well suited for aluminum anodized finishes or for painting. However, if the user desires a stainless steel, polished brass, satin or copper finish, the use of removable cladded side covers is preferable to provide uniform coloration. An example of such a cladded side cover 200 is illustrated in FIG. 4. As seen therein, a backing 201, preferably formed of extruded aluminum and having the same configuration as side cover 80 and 82 is employed and a thin outer metal sheet 202 formed of the desired outer cover material is adhered to the outer surface of the backing 201 by means of double-sided adhesive tape 202 or other suitable adhesive. As seen in FIG. 4, the outer metal sheet 202 extends adjacent to the flat surface on the backing 201 and the securement of the cladded cover 200 is provided by the flange 204 and upstanding lips 206 formed by the backing 201 in the same manner as described above with respect to decorative side plates 80 and 82.

While the present invention was illustrated with respect to a support rail configuration employing a tapered upper portion, the invention could also be employed with rail sections having different configurations, different clamping mechanisms and different side cover configurations.

FIG. 5 illustrates the use of a different side cover configuration with the same support rail sections 18 and 20 illustrated in FIGS. 1-3, giving the support rail 212 an overall rectangular appearance. As seen in FIG. 5, the side panels 280 and 282 define vertical side walls 280′ and 282′ that extend the entire height of the support rail 212 and are bent inwardly at their upper ends 280″ and 282″ respectively to define inwardly extending upper cover surfaces 280″′ and 282′″. Upper surfaces 280″′ and 282″′ terminate at their inner ends in downwardly extending flanges 288 and 290 respectively. Flanges 288 and 290 are slidably received in the grooves 76 and 78 in the upper mounting portions of the male and female rail sections 18 and 20 as previously discussed in connection with the depending flanges 88 and 90 on side covers 80 and 82. The lower ends of the vertical side walls of side covers 280 and 282′ define inwardly extending flanges 292 and 294 that terminate in upstanding lips 296 and 298 that cooperate with the lower ends of the rail sections 18 and 20 in the same manner as previously described in connection with the side covers 80 and 82. Thus, by varying the configuration of the walls of the side covers, the outer configuration of the support rails can be varied as well as the decorative finish thereon.

Other rail configurations also could be employed in the present invention, as could different mechanisms for drawing together the two rail sections to effect securement of the rails to the glass panels and mounting surfaces. Insofar as such changes and modifications are within the purview of the appended claims, they are to be considered as part of the present invention.

What is claimed is:

1. A support rail having replaceable decorative side covers for mounting a glass panel on a window or door frame or other mounting structure, said rail comprising:
a first longitudinally extending rail section; a second longitudinally extending rail section disposed adjacent to said first section and cooperating with said first section to define an upper U-shaped channel for receiving an edge portion of a glass panel and a lower inverted U-shaped channel for receiving a portion of a mounting structure; a clamping assembly carried by said rail sections for operatively connecting said rail sections in an adjacent disposition and drawing said sections together to effect securement of a glass panel to said rail and of said rail to a mounting structure for the mounting of the panel on the structure; a pair of decorative side covers, one of said covers being slidably mounted on each of said rail sections for providing said support rail with a decorative appearance; and a pair of end plates removably mounted on said rail sections for selectively holding said side covers in place on said sections and allowing said covers to be slide from said sections for replacement.

2. The support rail of claim 1 wherein said first and second rail sections each define a longitudinally extending upper surface adjacent to an upper end of said U-shaped channel and a longitudinally extending lower surface adjacent to a lower end of said inverted U-shaped channel, and wherein each of said side covers defines a first flange extending longitudinally along an upper edge portion thereof and a second flange extending longitudinally along a lower edge portion thereof, said first flange on each of said side covers slidably engaging one of said upper surfaces defined by said rail sections and said second flange on each of said side covers slidably engaging one of said lower surfaces defined by said rail sections whereby said side covers are selectively held in place by said rail sections.

3. The support rail of claim 2 wherein said upper surfaces of said first and second rail sections each define a longitudinally extending groove therein, said grooves extending in parallel disposition along said support rail, said lower surfaces of said rail sections each define a relief area therein, said first flanges on each of said side covers being slidably disposed within one of said grooves in said upper surfaces and said second flanges on each of said side covers extending about one of said lower surfaces on said rail sections and into one of said relief areas, whereby said first and second flanges cooperate with said end plates to releasably secure said side covers to said support rail.

4. The support rail of claim 1 wherein first and second rail sections each define a longitudinally extending upper surface adjacent to an upper end of said U-shaped channel and a longitudinally extending lower surface adjacent to a lower end of said inverted U-shaped channel, and wherein each of said side covers includes a rigid backing and a decorative metal sheet, said backing defining a support surface, a first flange extending longitudinally along an upper edge portion of said backing and a second flange extending longitudinally along a lower edge portion of said backing, said decorative sheet being bonded to said support surface of said backing, and wherein said first flanges on said backings slidably engage said upper surfaces defined by said first and second rail sections and said second flanges on said backings slidably engage said lower surfaces defined by said rail sections whereby said side covers are selectively held in place by said rail sections.

5. A support rail having replaceable decorative side covers for mounting a glass panel on a window or door frame or other mounting structure, said rail comprising:
a first longitudinally extending rail section defining an upper mounting portion, a lower mounting portion and a horizontal flange projecting inwardly between said upper and lower mounting portions, said upper mounting portion defining an upper vertical clamping surface and an inwardly extending horizontal support surface and said lower mounting portion of said first rail section defining a lower vertical clamping surface and an inwardly extending horizontal surface;
a second longitudinally extending rail section defining an upper mounting portion, a lower mounting portion and a recess disposed between said upper and lower mounting portions of said second rail section, said upper mounting portion defining an upper vertical clamping surface and an inwardly extending horizontal support surface and said lower mounting portion of said second rail section defining a lower vertical clamping surface and an inwardly extending horizontal surface;
a clamping assembly carried by said first and second rail sections for operatively connecting said first and second rail sections in an adjacent disposition such that said horizontal flange on said first rail section projects into said recess in said second rail section, said upper vertical clamping surfaces and horizontal support surfaces cooperate to define an upper U-shaped channel for receiving an edge portion of a glass panel and said lower vertical clamping surfaces and said inwardly extending horizontal surface on said first rail section cooperate to define a lower inverted U-shaped channel for receiving a portion of a mounting structure, said clamping assembly additionally drawing said rail sections together to effect securement of a glass panel to said rail and of said rail to a mounting structure for the mounting of the panel on the structure;
a pair of decorative side covers, one of said covers being slidably mounted on each of said rail sections for providing said support rail with a decorative appearance; and
a pair of end plates removably mounted on said rail sections for selectively holding said side covers in place on said sections and allowing said covers to be slide from said sections for replacement.

6. The support rail of claim 5 wherein said upper mounting portions of said first and second rail sections each define a longitudinally extending upper surface adjacent to an upper end of said U-shaped channel, and said lower mounting portions of said rail sections each define a lower longitudinally extending lower surface adjacent to a lower end of said inverted U-shaped channel, and wherein each of said side covers defines a first flange extending longitudinally along an upper edge portion thereof and a second flange extending longitudinally along a lower edge portion thereof, said first flange on each of said side covers slidably engaging one of said upper surfaces defined by said upper mounting portions of said rail sections and said second flange on each of said side covers slidably engaging one of said lower surfaces defined by said lower mounting portions of said rail sections whereby said side covers are selectively held in place by said rail sections.

7. The support rail of claim 5 wherein first and second rail sections each define a longitudinally extending upper surface adjacent to an upper end of said U-shaped channel and a longitudinally extending lower surface adjacent to a lower end of said inverted U-shaped channel, and wherein each of said side covers includes a rigid backing and a decorative metal sheet, said backing defining a support surface, a first flange extending longitudinally along an upper edge portion of said backing and a second flange extending longitudinally along a lower edge portion of said backing, said decorative sheet being bonded to said support surface of said backing, and wherein said first flanges on said backings slidably engage said upper surfaces defined by said first and second rail sections and said second flanges on said backings slidably engage said lower surfaces defined by said rail sections whereby said side covers are selectively held in place by said rail sections.

8. The support rail of claim 6 wherein said upper surfaces of said first and second rail sections each define a longitudinally extending groove therein, said grooves extending in parallel disposition along said support rail, said lower surfaces of said rail sections each define a relief area therein, said first flanges on each of said side covers being slidably disposed within one of said grooves in said upper surfaces and said second flanges on each of said side covers extending about one of said lower surfaces on said rail sections and into one of said relief areas, whereby said first and second flanges cooperate with said end plates to releasably secure said side covers to said support rail.

9. The support rail of claim 7 wherein said upper surfaces of said first and second rail sections each define a longitudinally extending groove therein, said grooves extending in parallel disposition along said support rail, said lower surfaces of said rail sections each define a relief area therein, said first flanges on each of said side covers being slidably disposed within one of said grooves in said upper surfaces and said second flanges on each of said side covers extending about one of said lower surfaces on said rail sections and into one of said relief areas, whereby said first and second flanges cooperate with said end plates to releasably secure said side covers to said support rail.
